(19) United States
(12) Patent Application Publication
(10) Pub. No.: US 2016/0267529 A1
(43) Pub. Date: Sep. 15, 2016

(54) Method and System of Detecting Malicious Video Advertising Impressions

(71) Applicant: QUALCOMM Incorporated, San Diego, CA (US)

(72) Inventors: Bjorn Marcus Jakobsson, Portolla Valley, CA (US); Rajarshi Gupta, Sunnyvale, CA (US); Alexander Gantman, Solana Beach, CA (US); Seyedhossein Siadati, Semnan (IR)

(21) Appl. No.: 14/642,414

(22) Filed: Mar. 9, 2015

(51) Int. Cl. G06Q 30/02

(52) U.S. Cl. CPC G06Q 30/0248

(57) ABSTRACT

The embodiments include methods and systems for detecting advertising fraud in a computing device by monitoring information received in a receiver component of the computing device, monitoring information received in a render component of the computing device, comparing the information received in the receiver component to the information received in the render component to generate comparison results, using the comparison results to determine whether there are discrepancies between the received information and the rendered information, and performing fraud prevention operations in response to determine that there are discrepancies between the received information and the rendered information. The fraud prevention operations may include dropping a connection to cease receiving the information in the receiver component, sending negative or position feedback to the service provider or a security server, and performing other similar operations.

### FIELD OF THE INVENTION

The present invention relates generally to methods, systems, and devices for preventing advertising services from fraudulently altering the way advertisements are displayed on an electronic display of a consumer's computing device.

### BACKGROUND

Wireless communication technologies and mobile electronic devices (e.g., cellular phones, tablets, laptops, etc.) have grown in popularity and use over the past several years. To keep pace with increased consumer demands, mobile electronic devices have become more feature rich, and now commonly include multiple processors, system-on-chips (SoCs), and other resources that allow mobile device users to execute complex and power intensive software applications (e.g., web browsers, video streaming applications, etc.) on their mobile devices. Due to these and other improvements, smartphones and tablet computers have grown in popularity, and are replacing laptops and desktop machines as the platform of choice for many users.

Mobile device users can now accomplish many of their daily tasks with ease and convenience by accessing the Internet via browser applications on their mobile device. This increase in popularity and use has created a significant market for generating and displaying advertisements on an electronic display of a computing device via a browser application, as well as opportunities for rouge advertising services to commit fraud on the advertisers by altering the way in which advertisements are displayed or rendered by the computing device. As such, improved solutions that allow a computing device to prevent advertising services from committing fraud on the advertiser will be beneficial to the advertisers and to the users of computing devices.

### SUMMARY

The various embodiments include methods of detecting advertising fraud in a computing device, including monitoring information received in a receiver component of the computing device, monitoring information received in a render component of the computing device, comparing the information received in the receiver component to the information received in the render component to generate comparison results, and determining whether there are discrepancies between the received information and the rendered information based on the comparison results.

In an embodiment, the method may include performing fraud prevention operations in response to determining that there are discrepancies between the received information and the rendered information. In a further embodiment, performing fraud prevention operations may include dropping a connection to cease receiving the information in the receiver component. In a further embodiment, performing fraud prevention operations may include sending negative feedback to another component. In a further embodiment, performing fraud prevention operations may include sending positive feedback to another component. In a further embodiment, monitoring information received in the receiver component may include monitoring information received in a modem processor. In a further embodiment, monitoring information received in the receiver component may include monitoring network connections and HTTP requests sent from a server.

In a further embodiment, monitoring information received in the render component may include monitoring information received in a graphics processor. In a further embodiment, monitoring information received in the render component may include determining whether received audio is output by the device. In a further embodiment, determining whether there are discrepancies between the received information and the rendered information may include determining whether the comparison results exceed a predefined threshold.

In a further embodiment, comparing the information received in the receiver component to the information received in the render component to generate comparison results may include determining an incoming entropy of the information received in the receiver component, determining the display entropy of the information received in the render component, and comparing the incoming entropy to the display entropy to generate the comparison results. In a further embodiment, the comparison results may identify a difference between the incoming entropy and display entropy, and the method may further include generating an alert message in response to determining that the difference between the incoming entropy and display entropy is greater than a threshold value.

Further embodiments may include a computing device having a receiver component, a render component, and a processor coupled to the receiver component and the render component. The processor may be configured with processor-executable instructions to perform operations including monitoring information received in the receiver component, monitoring information received in the render component, comparing the information received in the receiver component to the information received in the render component to generate comparison results, and determining whether there are discrepancies between the received information and the rendered information based on the comparison results.

In an embodiment, the processor may be configured with processor-executable instructions to perform operations further including performing fraud prevention operations in response to determining that there are discrepancies between the received information and the rendered information. In a further embodiment, the processor may be configured with processor-executable instructions to perform operations such that performing fraud prevention operations includes dropping a connection to cease receiving the information in the receiver component. In a further embodiment, the processor may be configured with processor-executable instructions to perform operations such that performing fraud prevention operations includes sending negative feedback to another component. In a further embodiment, the processor may be configured with processor-executable instructions to perform operations such that performing fraud prevention operations includes sending positive feedback to another component. In a further embodiment, the processor may be configured with processor-executable instructions to perform operations such that monitoring information received in the receiver component includes monitoring information received in a modem processor, and monitoring information received in the render component includes monitoring information received in a graphics processor.

Further embodiments may include a non-transitory computer readable storage medium having stored thereon processor-executable software instructions configured to cause a processor of a computing device to perform operations including monitoring information received in a receiver component, monitoring information received in a render component, comparing the information received in the receiver component to the information received in the render component to generate comparison results, and determining whether there are discrepancies between the received information and the rendered information based on the comparison results.

In an embodiment, the stored processor-executable software instructions may be configured to cause a processor to perform operations further including performing fraud prevention operations in response to determining that there are discrepancies between the received information and the rendered information. In a further embodiment, the stored processor-executable software instructions may be configured to cause a processor to perform operations such that performing fraud prevention operations includes dropping a connection to cease receiving the information in the receiver component. In a further embodiment, the stored processor-executable software instructions may be configured to cause a processor to perform operations such that performing fraud prevention operations includes sending negative feedback to another component. In a further embodiment, the stored processor-executable software instructions may be configured to cause a processor to perform operations such that performing fraud prevention operations includes sending positive feedback to another component. In a further embodiment, the stored processor-executable software instructions may be configured to cause a processor to perform operations such that monitoring information received in the receiver component includes monitoring information received in a modem processor, and monitoring information received in the render component includes monitoring information received in a graphics processor.

Further embodiments may include a computing device that includes means for monitoring information received in a receiver component, means for monitoring information received in a render component, means for comparing the information received in the receiver component to the information received in the render component to generate comparison results, and means for determining whether there are discrepancies between the received information and the rendered information based on the comparison results.

In an embodiment, the computing device may include means for performing fraud prevention operations in response to determining that there are discrepancies between the received information and the rendered information. In a further embodiment, means for performing fraud prevention operations may include means for dropping a connection to cease receiving the information in the receiver component. In a further embodiment, means for performing fraud prevention operations may include means for sending negative feedback to another component. In a further embodiment, means for performing fraud prevention operations may include means for sending positive feedback to another component. In a further embodiment, means for monitoring information received in the receiver component may include means for monitoring information received in a modem processor, and means for monitoring information received in the render component may include means for monitoring information received in a graphics processor.

### BRIEF DESCRIPTION OF THE DRAWINGS

The accompanying drawings, which are incorporated herein and constitute part of this specification, illustrate exemplary embodiments of the invention. Together with the general description given above and the detailed description given below, the drawings serve to explain features of the invention not to limit the disclosed embodiments.

FIG. 1 is a component block diagram illustrating an example system-on-chip (SOC) architecture that may be used in computing devices implementing the various embodiments.

FIG. 2 is a block diagram illustrating one type of advertising fraud that may be detected by an embodiment computing device.

FIG. 3 is functional block diagram illustrating example logical and functional components that may be included in a computing device that is configured to detect and respond to advertising frauds in accordance with the various embodiments.

FIG. 4 is a process flow diagram illustrating an embodiment method of identifying and responding to advertising frauds.

FIG. 5 is a component block diagram of a lap top computer suitable for implementing the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, the various embodiments include methods, and computing devices configured to implement the methods, of identifying fraudulent advertising services based on the manner in which content is displayed/rendered in the computing device. In an embodiment, the computing device may be configured to identify discrepancies between the amount of audio/video information that is received and the amount of audio/video information that is rendered. In response to identifying a large discrepancy (i.e., exceeding a threshold difference) between the input (which is the radio stream) and the output (which is the rendered data—or the stream being handled by the graphics card), the computing device may perform one or more fraud prevention operations.

For example, the computing device may be configured to determine whether the frame size in which audio/video content is displayed is much smaller than expected based on the original size of the audio/video content, and take an action, such as terminating the traffic to the radio when that condition is detected. Terminating the traffic to the radio may be accomplished by dropping the connection so that all the data coming into the radio (which appears to the advertiser as “user is watching”) is dropped. As another example of the fraud prevention operations, in response to detecting a significant difference between rendered and expected content, the computing device may send negative or positive feedback (potentially via an aggregator) to the service provider or a security server that informs the advertiser of the fraud and/or takes other appropriate actions. For example, an aggregator may count the views and send this information along with context information (such as what was the webpage, who was the referrer to the webpage, etc.) to an auditor or to the network. Alternatively or in addition, when a dramatic change in how the advertisement is displayed is detected, the computing device may convey this information to a broker, a security service provider, an auditor, or the network so that they may take an appropriate action.

The word “exemplary” is used herein to mean “serving as an example, instance, or illustration.” Any implementation described herein as “exemplary” is not necessarily to be construed as preferred or advantageous over other implementations.

The terms “mobile device,” and “mobile computing device” may be used interchangeably herein, and may refer to any one or all of cellular telephones, smartphones, personal or mobile multi-media players, personal data assistants (PDA's), laptop computers, tablet computers, smartbooks, palm-top computers, wireless electronic mail receivers, multimedia Internet enabled cellular telephones, wireless gaming controllers, and similar personal electronic devices which include a programmable processor and a memory.

Advertising services may charge corporations/advertisers based on the number of impressions or cost per mille (CPM), cost per click (CPC), or cost per action (CPA). The CPM advertising method allows the advertising service to send audio/video content from an advertiser to a consumer's computing device, and charge the advertiser for each unit of audio/video content that is sent to the device. For example, the advertising service may upload a content video to Youtube®, force users to view an advertisement before viewing the content video, and charge the corporation/advertiser for each advertisement viewed by the user.

Using existing technologies, the corporation/advertiser will know whether all or portions the advertisement was received by the device, but not the manner in which the advertisement was rendered on the device. Therefore, a fraudulent advertising service may send a large number of advertisements to a computing device, simultaneously display each advertisement in a small frame (e.g., a zero IFrame) or using a few pixels, and charge the corporations/advertisers for all of the advertisements. This is a fraud because the user is not likely to have viewed (or even known about) the advertisements for which the corporations/advertisers are billed. Yet, there is currently no easy way for corporations/advertisers or the ad infrastructure to detect or identify these fraudulent advertising services.

The various embodiments include computing devices configured to identify discrepancies between the amount of information that is received in the device (e.g., in modem processor) and the amount of information that is rendered on the device (e.g., sent to the graphics processor for rendering on an electronic display), and take an action in response. For example, a computing device may be configured to determine that there is a significant discrepancy between the amount of information that is received and the amount of information that is rendered when the computing device receives 5 MB of 1080 P video data but renders 1 KB of data via 10 pixels.

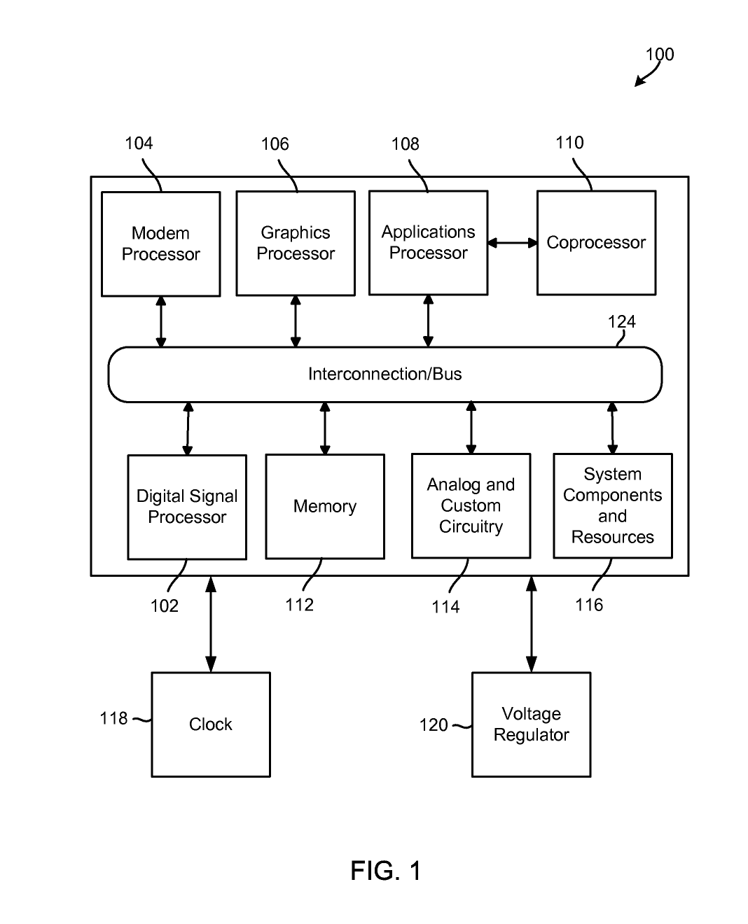

The various embodiments may be implemented on a number of computing devices, including computing devices with a single processor and multiprocessor computer systems, including a system-on-chip (SOC). FIG. 1 illustrates an example system-on-chip (SOC) 100 architecture that may be used in computing devices implementing the various embodiments. The SOC 100 may include a number of heterogeneous processors, such as a digital signal processor (DSP) 103, a modem processor 104, a graphics processor 106, and an application processor 108. The SOC 100 may also include one or more coprocessors 110 (e.g., vector co-processor) connected to one or more of the heterogeneous processors (e.g., DSP 103, modem processor 104, etc.). Each processor (e.g., DSP 103, modem processor 104, etc.) may include one or more cores, and each processor/core may perform operations independent of the other processors/cores. For example, the SOC 100 may include a processor that executes a first type of operating system (e.g., FreeBSD, LINUX, OS X, etc.) and a processor that executes a second type of operating system (e.g., Microsoft Windows 8).

The SOC 100 may also include analog circuitry and custom circuitry 114 for managing sensor data, analog-to-digital conversions, wireless data transmissions, and for performing other specialized operations, such as processing encoded audio and video signals for rendering in a web browser. The SOC 100 may further include system components and resources 116, such as voltage regulators, oscillators, phase-locked loops, peripheral bridges, data controllers, memory controllers, system controllers, access ports, timers, and other similar components used to support the processors and software clients (e.g., a web browser) running on a computing device.

The system components and resources 116 and/or custom circuitry 114 may include circuitry to interface with peripheral devices, such as cameras, electronic displays, wireless communication devices, external memory chips, etc. The processors (e.g., DSP 103, modem processor 104, etc.) may be interconnected to one or more memory elements 112, system components and resources 116, and custom circuitry 114 via an interconnection/bus module 124, which may include an array of reconfigurable logic gates and/or implement a bus architecture (e.g., CoreConnect, AMBA, etc.). Communications may be provided by advanced interconnects, such as high performance networks-on chip (NoCs).

The SOC 100 may further include an input/output module (not illustrated) for communicating with resources external to the SOC, such as a clock 118 and a voltage regulator 120. Resources external to the SOC (e.g., clock 118, voltage regulator 120) may be shared by two or more of the internal SOC processors/cores (e.g., a DSP 103, a modem processor 104, a graphics processor 106, an applications processor 108, etc.).

In an embodiment, the SOC 100 may be included in a mobile device 102, such as a smartphone. The mobile device 102 may include communication links for communication with a telephone network, the Internet, and/or a network server. Communication between the mobile device 102 and the network server may be achieved through the telephone network, the Internet, private network, or any combination thereof.

In various embodiments, the SOC 100 may be configured to collect behavioral, state, classification, modeling, success rate, and/or statistical information in the mobile device, and send the collected information to the network server (e.g., via the telephone network) for analysis. The network server may use information received from the mobile device to generate, update or refine classifiers or data/behavior models that are suitable for use by the SOC 100 when identifying and/or classifying performance-degrading mobile device behaviors. The network server may send data/behavior models to the SOC 100, which may receive and use data/behavior models to identify suspicious or performance-degrading mobile device behaviors, software applications, processes, etc.

The SOC 100 may also include hardware and/or software components suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well known components (e.g., accelerometer, etc.) of modern electronic devices.

In addition to the mobile device 102 and SOC 100 discussed above, the various embodiments may be implemented in a wide variety of computing systems, which may include a single processor, multiple processors, multicore processors, or any combination thereof.

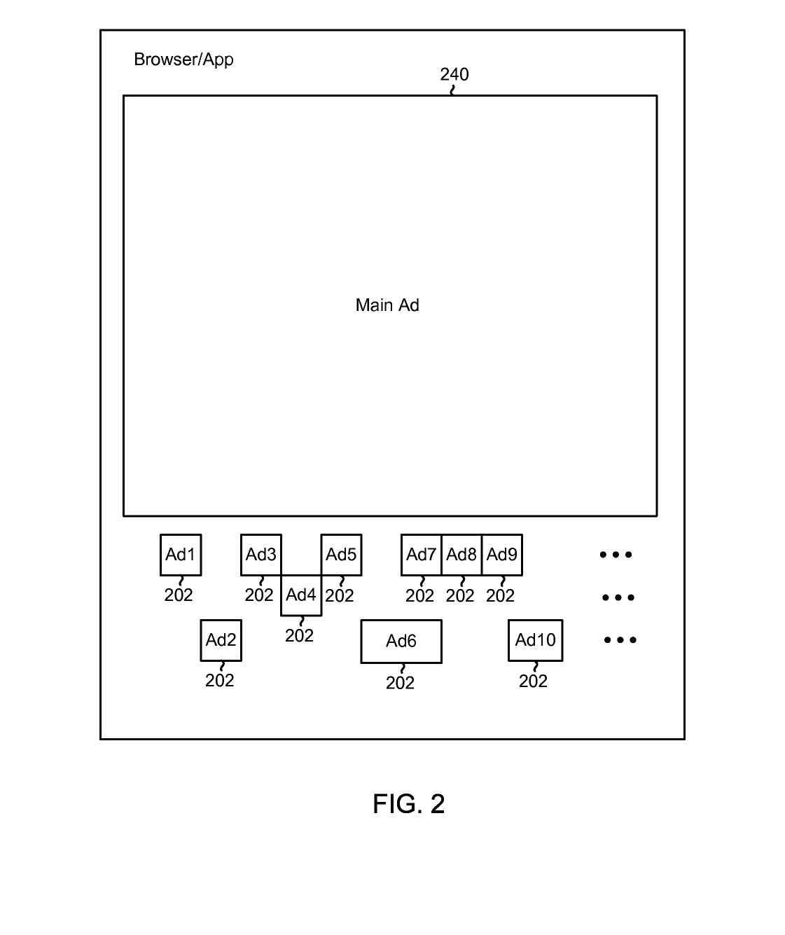

FIG. 2 illustrates an example of a fraudulent advertisement service that may be detected by a computing device implementing an embodiment method. Generally, fraudulent advertisement service do not want to display the ad to the end user (user that is supposed to be watching the advertisement). This is because there is a high probability that the end user would become annoyed by the number of ads being displayed, and terminate the application, close the browser, or navigate to another site. Therefore, the fraudulent advertisement service typically hides the advertisement in very small windows or zero-sized Iframes 202. The “zero-size” suggests that the Iframe is so small that it is not visible to the human eye, often a single pixel of the screen. This allows for several zero size pixels to display/play at the same time as a main ad 204 or application without the user's knowledge.

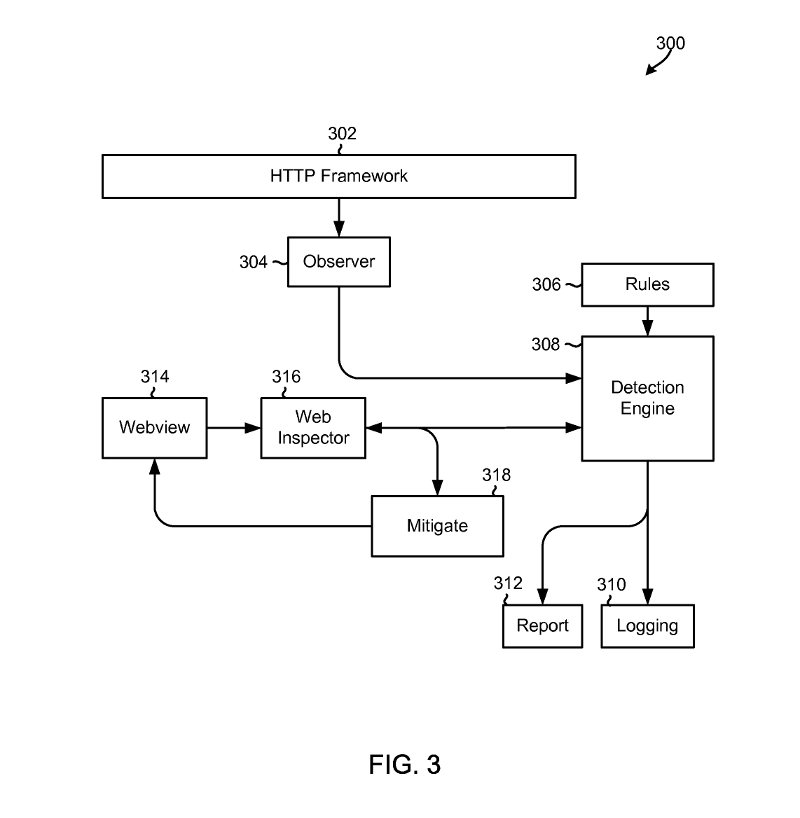

FIG. 3 illustrates an example computing system 300 configured to identify and respond to discrepancies between the input to the radio stream and outputs to the graphics card. In the example illustrated in FIG. 3, the system 300 includes an HTTP framework 302 module, an observer 304 module, a rules 306 module, a detection engine 308, a logging 310 module, a report 312 module, a webview 314 app module, a web inspector 316 module, and a mitigation 318 module.

The computing system 300 may be configured to operate based on a set of pre-defined rules (e.g., via the rules 306 module) that define a malicious structure and behaviors of the page based on received features. In an exemplary and very light-weight design, the detection engine 308 may work in two steps and/or based on two rule levels. The rules in the first level (level 1) may define suspicious or susceptible behaviors, such as large numbers of HTTP requests from the HTTP Framework 302, or requesting many media type elements, loading elements from known ads distributors, etc. These are common indicators of fraud, although there is no assurance that this condition corresponds to fraud; nor is there any guarantee that fraud corresponds to this condition.

In the second level (level 2), which may be implemented upon detection of suspicious activity or as part of routine activity surveillance, the detection engine 308 may request that the web inspector 316 locate and report (e.g., via the report 312 module) the presentation of the advertisement for suspicious contents, including how the content is represented and its location in the electronic display of the device. For example, if the frame size for displaying content is very small or very small in comparison with the original size of a video, then this activity may be marked as non-benign or malicious. This can also be represented in terms of the bandwidth into the device (for the streaming of a particular video element), in relation to the bandwidth presented to the user on the screen.

Typically, due to careful formatting made by the content provider, no “unnecessary data” is transmitted. However, the bandwidths are not necessarily identical, as the over-network bandwidth is used for compressed material, and a different compression (or no compression at all) may be used between the GPU and the electronic display or screen. As such, the web inspector 316 may assess the entropy of the incoming stream and the displayed stream, compare these to each other, and signal an alert when the displayed stream is significantly lower than the incoming stream (or lower than expected). Similarly, a sound component of the transmission (received via HTTP Framework 302) may be assessed to determine whether the sound is conveyed to the user. For example, if the volume and speakers are on in the device, but no sound is being conveyed (e.g., due to the browser or app turning the volume off, etc.), this may be marked as a form of abuse.

Based on whether abuse is identified, a security action is taken. A variety of security actions are possible. One security action is to close the window or application (e.g., webview 314 app, etc.) or terminate the receipt of a stream tagged as undesirable in response detecting/identifying one or more forms of abuse. Alternatively, if abuse is detected, information relating to the session and a message clarifying the type of abuse may be sent to a proxy or an entity associated with the service provision. Alternatively, if no abuse is detected, information relating to the session along with a message stating that no abuse was detected is conveyed to a proxy or an entity associated with the service provision.

In addition, if the content is not played or played under other layers in the page, the detection engine 308 will mark this as malicious behavior or fraudulent advertising.

As an optional embodiment, the system may log all the activities of the application for further reference. This log may be reported to the ad provider or ad network. The ad provider or ad network can check the condition in which its ads is represented and to compute how to pay the company. As a second optional embodiment, the incidents of malicious behavior may be reported to a credibility scoring system for reference of advertisers. Such credibility system will be a base to select appropriate target websites to show the ads.

As an optional component, the system may include a mitigation 318 module that is configured to stop malicious activity in the webpage or webview 314 app. For example, the mitigation 318 module may force the webview 314 (which is software that many browsers and apps are built from) to stop streaming a video that is not being presented to user.

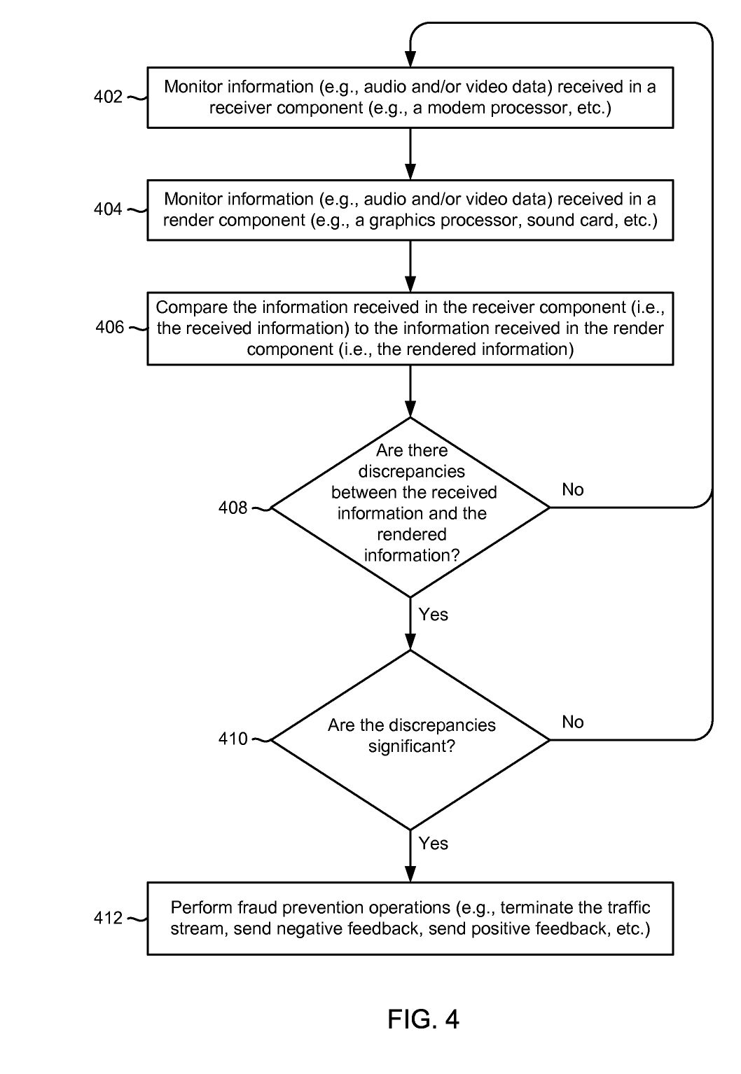

FIG. 4 illustrates an embodiment method 400 of identifying and responding to advertising fraud. Method 400 may be performed by a processor or processing core of a computing device. In block 402, the processor may monitor information (e.g., audio data, video data, etc.) that is received in a receiver component (e.g., a modem processor 104, etc.) of the computing device. For example, in an embodiment, the processor may monitor network connections and HTTP requests sent from a server and received in a modem of the computing device (e.g., in block 402). In block 404, the processor may monitor information (e.g., audio and/or video data) received in a render component (e.g., a graphics processor 106, sound card, etc.) of the computing device. For example, monitoring information received in the render component may include determining whether received audio information is output by the computing device.

In block 406, the processor may compare the information received in the receiver component (i.e., the received information) to the information received in the render component (i.e., the rendered information) to generate comparison results. For example, in an embodiment, the processor may determine an incoming entropy of the information received in the receiver component, determine a display entropy of the information received in the render component, and compare the incoming entropy to the display entropy to generate the comparison results that identify a difference between the incoming entropy and display entropy.

In determination block 408, the processor may determine whether there are discrepancies between the received information and the rendered information. In response to determining that there are no discrepancies between the received information and the rendered information (i.e., determination block 408=“No”), the processor may continue monitoring the information (e.g., audio data, video data, etc.) received in a receiver component (e.g., in block 402).

In response to determining that there are discrepancies between the received information and the rendered information (i.e., determination block 408=“Yes”), the processor may determine whether the discrepancies are significant such as by comparing the differences to a threshold value in determination block 410. Such a threshold may be predetermined to be sufficiently large to avoid false alarms due to differences due to data added in transmission not relevant to rendering, differences in rendering due to the display size, differences due to the provided ad content including alternative presentation formats and content not used in rendering on the computing device, etc. Typically in the case of fraudulent ads the discrepancy is very large, such as orders of magnitude, so the threshold may be a large value in the units of measure (e.g., megabytes, pixels, etc.)

In response to determining that a discrepancy or discrepancies are not significant (i.e., determination block 410=“No”), the processor may continue monitoring the information (e.g., audio data, video data, etc.) received in a receiver component (e.g., in block 402). In response to determining that the discrepancies are significant (i.e., determination block 410=“Yes”), the processor may perform fraud prevention operations in block 412. For example, the processor may terminate the traffic to the radio chip or modem processor (such as the modem processor 104 illustrated in FIG. 1) by dropping the connection, send negative or positive feedback to the service provider or a security server, etc. In an embodiment, the fraud prevention operations may include generating an alert message, such as in response to determining that the difference between the incoming entropy and display entropy is greater than a threshold value, or that the display entropy is significantly lower than the incoming entropy or the display entropy is lower than expected.

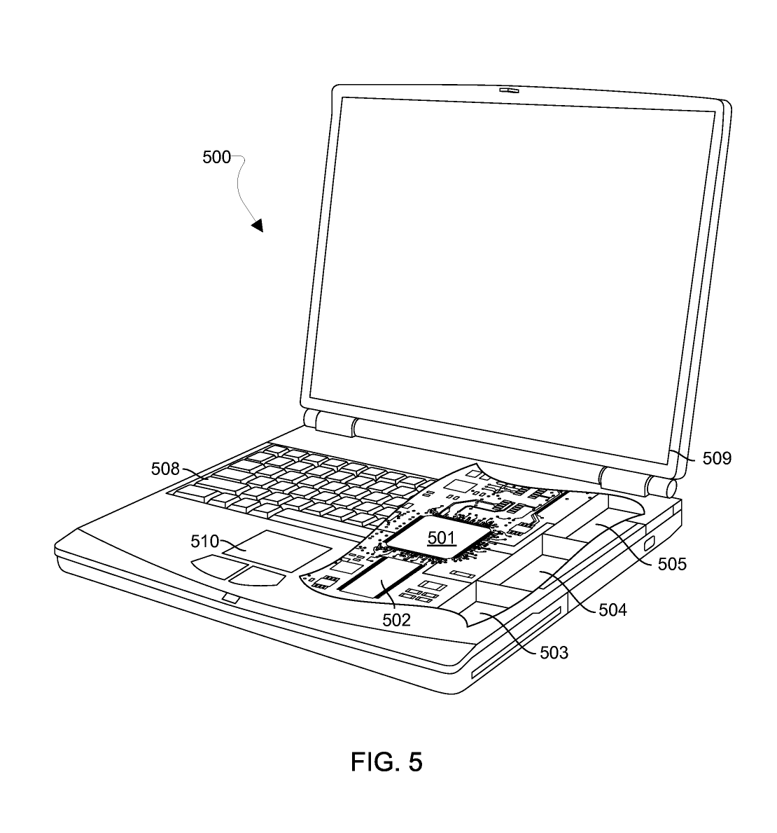

The various embodiments may be implemented on a variety of mobile computing devices, an example of which is illustrated in FIG. 5. Specifically, FIG. 5 illustrates an example personal laptop computer 500 that may be configured to implement the various embodiments. Such a personal laptop computer 500 generally includes a processor 501 coupled to volatile memory 502 and a large capacity nonvolatile memory, such as a disk drive 503. The personal laptop computer 500 may also include a compact disc (CD) and/or DVD drive 504 coupled to the processor 501. The personal laptop computer 500 may also include a number of connector ports coupled to the processor 501 for establishing data connections or receiving external memory devices, such as a network connection circuit 505 for coupling the processor 501 to a network. The personal laptop computer 500 may further be coupled to a keyboard 508, a pointing device such as a mouse 510, and a display 509 as is well known in the computer arts.

The processor 501 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor dedicated to wireless communication functions and one processor dedicated to running other applications. Typically, software applications may be stored in the internal non-volatile or volatile memory 502 before they are accessed and loaded into the processor 501. The processor 501 may include internal memory sufficient to store the application software instructions.

The various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g. program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP (e.g., the DSP 103 illustrated in FIG. 1, etc.) and a microprocessor, a plurality of microprocessors, one or more microprocessors in conjunction with a DSP core, or any other such configuration. Alternatively, some blocks or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-readable xor other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of detecting advertising fraud in a computing device, comprising:
monitoring information received in a receiver component of the computing device;
monitoring information received in a render component of the computing device;
comparing the information received in the receiver component to the information received in the render component to generate comparison results; and
determining whether there are discrepancies between the received information and the rendered information based on the comparison results.

2. The method of claim 1, further comprising:
performing fraud prevention operations in response to determining that there are discrepancies between the received information and the rendered information.

3. The method of claim 2, wherein performing fraud prevention operations comprises dropping a connection to cease receiving the information in the receiver component.

4. The method of claim 2, wherein performing fraud prevention operations comprises sending negative feedback to another component.

5. The method of claim 2, wherein performing fraud prevention operations comprises sending positive feedback to another component.

6. The method of claim 1, wherein monitoring information received in the receiver component comprises monitoring information received in a modem processor.

7. The method of claim 1, wherein monitoring information received in the receiver component comprises monitoring network connections and HTTP requests sent to a server.

8. The method of claim 1, wherein monitoring information received in the render component comprises monitoring information received in a graphics processor.

9. The method of claim 1, wherein monitoring information received in the render component comprises determining whether received audio is output by the computing device.

10. The method of claim 1, wherein determining whether there are discrepancies between the received information and the rendered information comprises determining whether the comparison results exceed a predefined threshold.

11. The method of claim 1, wherein comparing the information received in the receiver component to the information received in the render component to generate the comparison results comprises:
determining an incoming entropy of the information received in the receiver component;
determining the display entropy of the information received in the render component; and
comparing the incoming entropy to the display entropy to generate the comparison results.

12. The method of claim 11, wherein the comparison results identify a difference between the incoming entropy and display entropy, the method further comprising:
generating an alert message in response to determining that the difference between the incoming entropy and display entropy is greater than a threshold value.

13. A computing device, comprising:
a receiver component;
a render component; and
a processor coupled to the receiver component and the render component, wherein the processor is configured with processor-executable instructions to perform operations comprising:
monitoring information received in the receiver component;
monitoring information received in the render component;
comparing the information received in the receiver component to the information received in the render component to generate comparison results; and
determining whether there are discrepancies between the received information and the rendered information based on the comparison results.

14. The computing device of claim 13, wherein the processor is configured with processor-executable instructions to perform operations further comprising:
performing fraud prevention operations in response to determining that there are discrepancies between the received information and the rendered information.

15. The computing device of claim 14, wherein the processor is configured with processor-executable instructions to perform operations such that performing fraud prevention operations comprises dropping a connection to cease receiving the information in the receiver component.

16. The computing device of claim 14, wherein the processor is configured with processor-executable instructions to perform operations such that performing fraud prevention operations comprises sending negative feedback to another component.

17. The computing device of claim 14, wherein the processor is configured with processor-executable instructions to perform operations such that performing fraud prevention operations comprises sending positive feedback to another component.

18. The computing device of claim 13, wherein the processor is configured with processor-executable instructions to perform operations such that:
monitoring information received in the receiver component comprises monitoring information received in a modem processor; and
monitoring information received in the render component comprises monitoring information received in a graphics processor.

19. A non-transitory computer readable storage medium having stored thereon processor-executable software instructions configured to cause a processor of a computing device to perform operations comprising:
monitoring information received in a receiver component;
monitoring information received in a render component;
comparing the information received in the receiver component to the information received in the render component to generate comparison results; and
determining whether there are discrepancies between the received information and the rendered information based on the comparison results.

20. The non-transitory computer readable storage medium of claim 19, wherein the stored processor-executable software instructions are configured to cause a processor to perform operations further comprising:
performing fraud prevention operations in response to determining that there are discrepancies between the received information and the rendered information.

21. The non-transitory computer readable storage medium of claim 20, wherein the stored processor-executable software instructions are configured to cause a processor to perform operations such that performing fraud prevention operations comprises dropping a connection to cease receiving the information in the receiver component.

22. The non-transitory computer readable storage medium of claim 20, wherein the stored processor-executable software instructions are configured to cause a processor to perform operations such that performing fraud prevention operations comprises sending negative feedback to another component.

23. The non-transitory computer readable storage medium of claim 20, wherein the stored processor-executable software instructions are configured to cause a processor to perform operations such that performing fraud prevention operations comprises sending positive feedback to another component.

24. The non-transitory computer readable storage medium of claim 19, wherein the stored processor-executable software instructions are configured to cause a processor to perform operations such that:
monitoring information received in the receiver component comprises monitoring information received in a modem processor; and
monitoring information received in the render component comprises monitoring information received in a graphics processor.

25. A computing device, comprising:
means for monitoring information received in a receiver component;
means for monitoring information received in a render component;
means for comparing the information received in the receiver component to the information received in the render component to generate comparison results; and
means for determining whether there are discrepancies between the received information and the rendered information based on the comparison results.

26. The computing device of claim 25, further comprising:
means for performing fraud prevention operations in response to determining that there are discrepancies between the received information and the rendered information.

27. The computing device of claim 26, wherein means for performing fraud prevention operations comprises means for dropping a connection to cease receiving the information in the receiver component.

28. The computing device of claim 26, wherein means for performing fraud prevention operations comprises means for sending negative feedback to another component.

29. The computing device of claim 26, wherein means for performing fraud prevention operations comprises means for sending positive feedback to another component.

30. The computing device of claim 25, wherein:
means for monitoring information received in the receiver component comprises means for monitoring information received in a modem processor; and
means for monitoring information received in the render component comprises means for monitoring information received in a graphics processor.
